(19) United States
(12) Patent Application Publication
(10) Pub. No.: US 2013/0275079 A1
(43) Pub. Date: Oct. 17, 2013

(54) Tachometer for Low-Speed AC Generator

(71) Applicants: Kevin Cousineau, Ridgecrest, CA (US); William Erdman, Orinda, CA (US)

(72) Inventors: Kevin Cousineau, Ridgecrest, CA (US); William Erdman, Orinda, CA (US)

(73) Assignee: Clipper Windpower, LLC, Carpinteria, CA (US)

(21) Appl. No.: 13/447,791

(22) Filed: Apr. 16, 2012

(51) Int. Cl. G06F 15/00

(52) U.S. Cl. 702/145

(57) ABSTRACT

A tachometer for a generator is disclosed. The tachometer may include a plurality of filters configured to receive a plurality of generator phase signals, a plurality of zero-cross detectors, and a logic circuit. The filters may be configured to convert each phase signal into a corresponding filtered signal. The zero-cross detectors may be configured to generate pulse signals responsive to zero-crossings detected in each filtered signal. The logic circuit may be in communication with each zero-cross detector and configured to receive the pulse signals. The logic circuit may logically combine the pulse signals into a combined signal, and generate a tachometer signal based on the combined signal, wherein the tachometer signal corresponds to a rotational speed of the generator.

### FIELD OF THE DISCLOSURE

The present disclosure generally relates to wind turbines, and more particularly, relates to tachometers for determining the rotational speed of wind turbine generators.

### BACKGROUND OF THE DISCLOSURE

Tachometers are commonly used in power generation system, such as wind turbines, to measure the rotational speed of generators for monitoring and/or control purposes. One configuration for a tachometer involves a relatively small, single-phase alternating current (AC) synchronous generator that is driven by the primary generator. More specifically, the single-phase generator is driven by a pinion that engages a gear on the shaft of the primary generator or some other arrangement. The single-phase generator is typically configured to output a signal frequency that is a multiple of the shaft speed such that standard frequency calculations or logic will yield the rotational speed of the primary generator shaft. While the single-phase generator provides adequate resolutions for high speed applications, such tachometer configurations may provide insufficient resolutions when used with low-speed applications. In particular, a single-phase generator driven by a primary generator shaft rotating at relatively low speeds does not offer a resolution that is capable of quickly and accurately detecting and differentiating between subtle changes in speed, often resulting in inaccurate readings.

Another configuration of generator tachometry is the use of optical shaft encoders. These devices attach directly to the shaft under measurement and generate good resolution with a pulse output exceeding 4096 pulse per revolution. Although adequate for most measurements they need to be attached directly to the generator shaft. In the case of many modern wind turbines this is difficult to achieve as some turbine have multiply generator with no external shaft and other turbines, as discussed below, are direct driven and have not output shaft for that connection.

One low-speed application of generators involves direct drive wind turbines. Direct drive wind turbines drive a large diameter, low-speed generator directly from the rotor of the wind turbine and do not use a speed-increasing gearbox. Many designs for direct drive generators for a wind turbine do not provide a central or main shaft upon which a gear for driving a tachometer may be conveniently mounted. Furthermore, the speed of the main shaft is so low that the resolution of such standard tachometer configurations would not adequately detect changes in the rotational speed of the primary generator. One alternative may be to mount the tachometer near an outer circumference of the primary generator where the large diameter of the generator provides a detectable surface speed that is much greater than that of the main shaft. However, the outer circumference of a wind turbine generator is typically not suited for fitment with a gear set for driving a tachometer, and adding a gear to the generator design would come at an unjustifiable cost.

Accordingly, it would be beneficial to provide a tachometer for low-speed generators, such as for direct drive wind turbines, which offer greater resolution and easier implementation at minimal cost. Moreover, there is a need for a tachometer that is capable of accurately detecting subtle changes in the rotational speed of generators while requiring minimal changes to the design of the generator and its setting.

### SUMMARY OF THE DISCLOSURE

In accordance with one aspect of the present disclosure, a tachometer for a generator is disclosed. The tachometer may include a plurality of filters configured to receive a plurality of generator phase signals, a plurality of zero-cross detectors and a logic circuit. The filters may be configured to convert each phase signal into a corresponding filtered signal. The zero-cross detectors may be configured to generate pulse signals responsive to zero-crossings detected in each filtered signal. The logic circuit may be in communication with each zero-cross detector and configured to receive the pulse signals. The logic circuit may logically combine the pulse signals into a combined signal, and generate a tachometer signal based on the combined signal, wherein the tachometer signal corresponds to a rotational speed of the generator.

In accordance with another aspect of the present disclosure, a generator system is disclosed. The generator system may include a multi-phase stator, a rotor rotatably disposed within the stator, a plurality of zero-cross detectors, and a logic circuit. The rotor may have a plurality of poles configured to electromagnetically interact with the stator and induce a phase signal in each phase while rotating relative to the stator. The zero-cross detectors may be in communication with the phase signals and configured to generate pulse signals responsive to zero-crossings detected in each filtered signal. The logic circuit may be in communication with each zero-cross detector and configured to receive the pulse signals. The logic circuit may logically combine the pulse signals into a combined signal, and generate a tachometer signal based on the combined signal, wherein the tachometer signal corresponds to a rotational speed of the generator.

In accordance with yet another aspect of the present disclosure, a method of determining a rotational speed of a generator is disclosed. The method may receive a phase signal from each phase of the generator, generate a pulse signal based on zero-crossings detected in each phase signal, logically combine the pulse signal from each phase into a combined signal, generate a tachometer signal based on the combined signal, and calculate the rotational speed of the generator based on the tachometer signal, the number of phases, and the number of poles of the generator.

Other advantages and features will be apparent from the following detailed description when read in conjunction with the attached drawings.

### BRIEF DESCRIPTION OF THE DRAWINGS

For a more complete understanding of the disclosed methods and apparatuses, reference should be made to the embodiments illustrated in greater detail on the accompanying drawings, wherein:

FIG. 1 is a schematic illustration of a wind turbine, in accordance with at least some embodiments of the present disclosure;

FIG. 2 is a schematic illustration of an exemplary generator system that may be employed with the wind turbine of FIG. 1;

FIG. 3 is a schematic illustration of an exemplary tachometer that may be employed with the generator system of FIG. 2;

FIG. 4 is a schematic illustration of a filter, a limiter and a zero-cross detector that may be employed with the tachometer of FIG. 3;

FIG. 5 is a graphical illustration of sample phase input pulse signals and a combined, tachometer signal that may be generated by the logic circuit of FIG. 3; and

FIG. 6 is a diagrammatic illustration of an exemplary algorithm or method by which the logic circuit of FIG. 3 may determine generator speed based on the tachometer signal of FIG. 5.

While the following detailed description has been given and will be provided with respect to certain specific embodiments, it is to be understood that the scope of the disclosure should not be limited to such embodiments, but that the same are provided simply for enablement and best mode purposes. The breadth and spirit of the present disclosure is broader than the embodiments specifically disclosed and encompassed within the claims eventually appended hereto.

### DETAILED DESCRIPTION OF THE DISCLOSURE

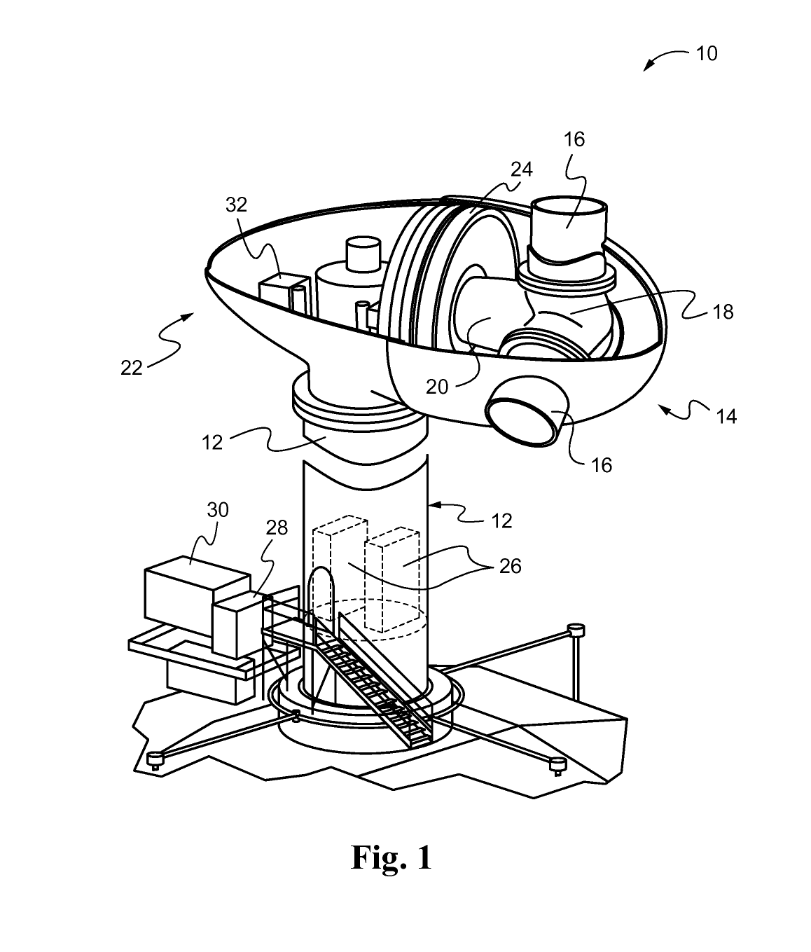

Referring to FIG. 1, an exemplary wind turbine 10 is shown, in accordance with at least some embodiments of the present disclosure. While all the components of the wind turbine 10 have not been shown and/or described, a typical wind turbine may include a tower section 12 and a rotor 14. The rotor 14 may include a plurality of blades 16 connected to a hub 18. The blades 16 may rotate with wind energy and the rotor 14 may transfer that energy to a main shaft 20 situated within a nacelle 22. The nacelle 22 may additionally house a generator system 24 configured to generate power in response to the wind energy. Power generated by the generator system 24 may be transmitted to inverters/converters situated within one or more generator control units (GCU) 26 positioned within the tower section 12, which in turn may transmit that power to a power distribution panel (PDP) 28 and a pad mount transformer (PMT) 30 for transmission to a grid. The generator system 24, GCUs 26, and other components within the wind turbine 10 may be operated under control by a turbine control unit (TCU) 32 situated within the nacelle 22.

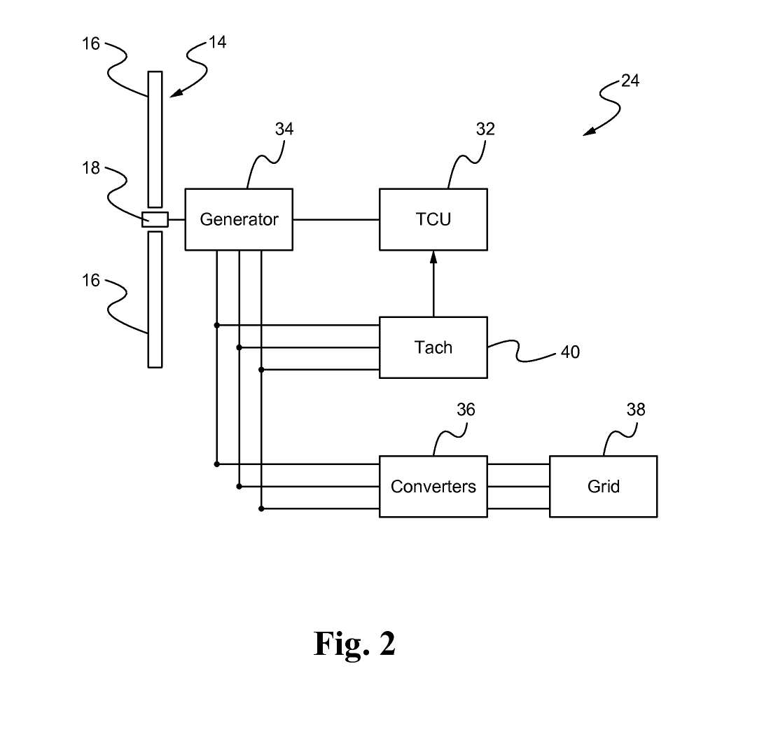

Turning now to FIG. 2, a schematic illustration of one exemplary generator system 24 for a wind turbine 10 is provided. As shown, for example, the generator system 24 may be configured for use with a direct drive wind turbine configuration and include a large diameter, low-speed generator 34. More specifically, the rotor of the generator 34 may be coupled directly to the rotor 14 via the main shaft 20 so as to eliminate the need for a drive train, and be caused to rotate in response to wind energy received at the blades 16. As is well known in the art, rotation of the rotor relative to the stator of the generator 34 may generate electrical energy, which may be further processed through the appropriate converters 36 and transmitted to a grid 38 for distribution. The generator 34 may be a multi-phase, multi-pole synchronous generator configured to generate a plurality of alternating current (AC) signals which are phase-shifted by a common phase offset.

Still referring to FIG. 2, the generator system 24 may also be provided with a virtual tachometer 40 that is in electrical communication with, for example, each of the generator 34 and the TCU 32. Specifically, the tachometer 40 may be configured to observe each of a plurality of phase signals generated at an output of the generator 34, and determine a rotational speed of the generator 34 based on the collective frequencies of the phase signals. By computing rotational speed information based on a plurality of phase signals, the tachometer 40 may be able to provide high resolution feedback to the TCU 32.

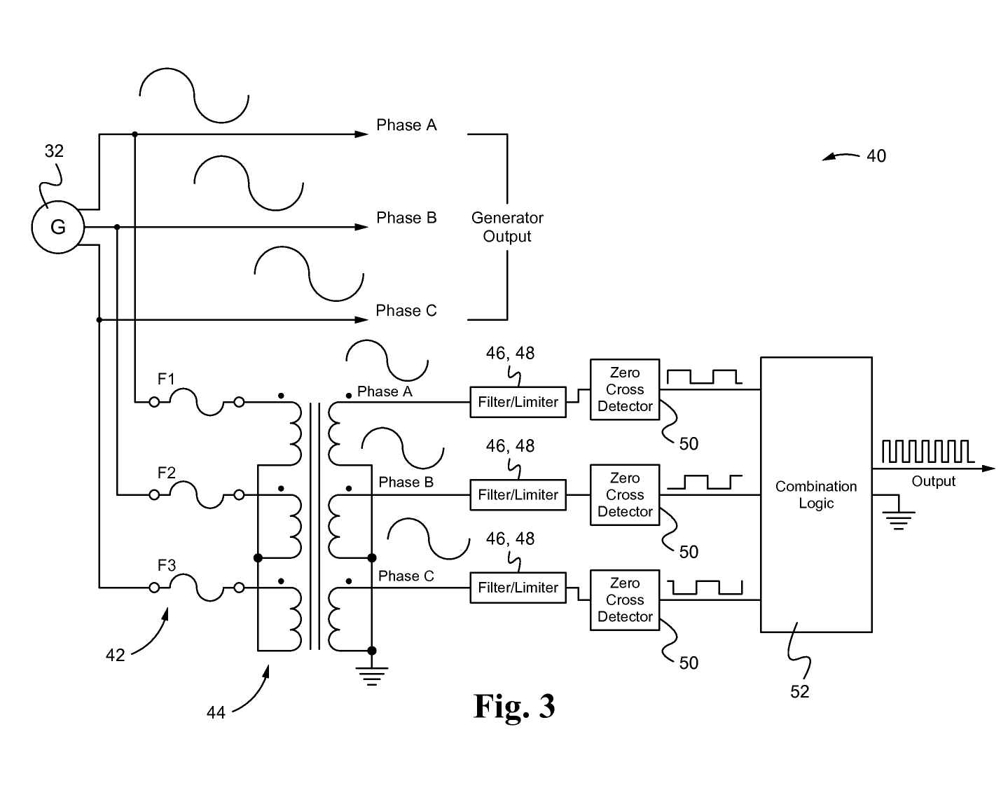

Referring now to FIG. 3, a general schematic of one exemplary tachometer 40 as constructed in accordance with the teachings of the present disclosure is provided. In the particular embodiment depicted, for example, the generator 34 may be a large diameter, low-speed synchronous generator 34 configured with three phases and multiple poles. Moreover, in response to any significant wind energy received at the blades 16 of the wind turbine 10, the rotor 14 and the generator 34 of FIG. 3 may be caused to rotate and produce three AC phase signals that are phase-shifted by a 120° offset. The tachometer 40 may be configured to communicate with each of the three phase signals of the generator 34, for example, via a series of fuses 42, or the like, each configured to receive a corresponding phase signal. The tachometer 40 may also include a step-down transformer 44, or the like, configured to receive each of the phase signals and reduce the voltage in the phase signals to more manageable levels. As shown, the phase signals may be individually transformed so as to maintain the phase offsets therebetween. The resulting three transformed signals may in turn be transmitted to individual filters 46 which may be configured to filter any high frequency noise from each transformed signal. The filters 46 may also include limiters 48 adapted to limit the peak voltage of each transformed phase signal to more manageable levels. As with the filters 46, the transformed phase signals may also be individually filtered and limited such that the phase offsets therebetween are so maintained.

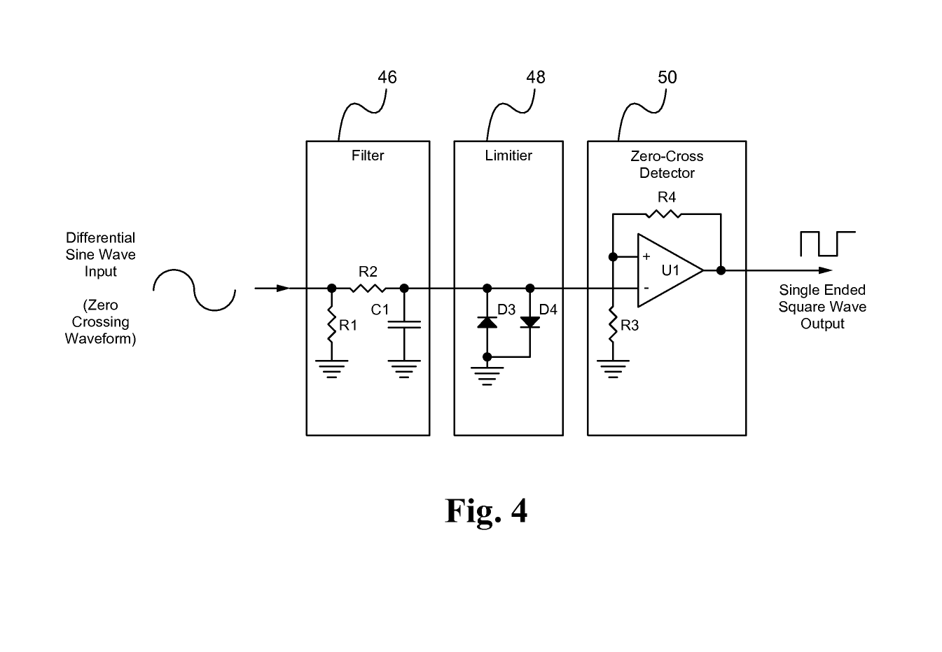

Still referring to FIG. 3, the resulting three filtered phase signals may be communicated to individual zero-cross detectors 50 for further processing. For example, the tachometer 40 may include three zero-cross detectors 50, one zero-cross detector 50 for each phase, configured to detect zero-crossings in each alternating phase signal. The zero-cross detectors 50 may be configured to generate square wave or pulse signals in response to each detected zero-crossing. As each of the phase signals, transformed signals, and filtered signals involves substantially alternating sine waves, or zero-crossing waveforms which periodically cross zero or ground, each zero-cross detector 50 may be able to generate a pulse signal which reflects the frequency of the associated phase in a more digitally readable format. As depicted in FIG. 4 and at the outputs of the zero-cross detectors 50 in FIG. 3, for example, each resulting pulse signal may include single-ended square waves corresponding to the zero-crossings in the associated phase.

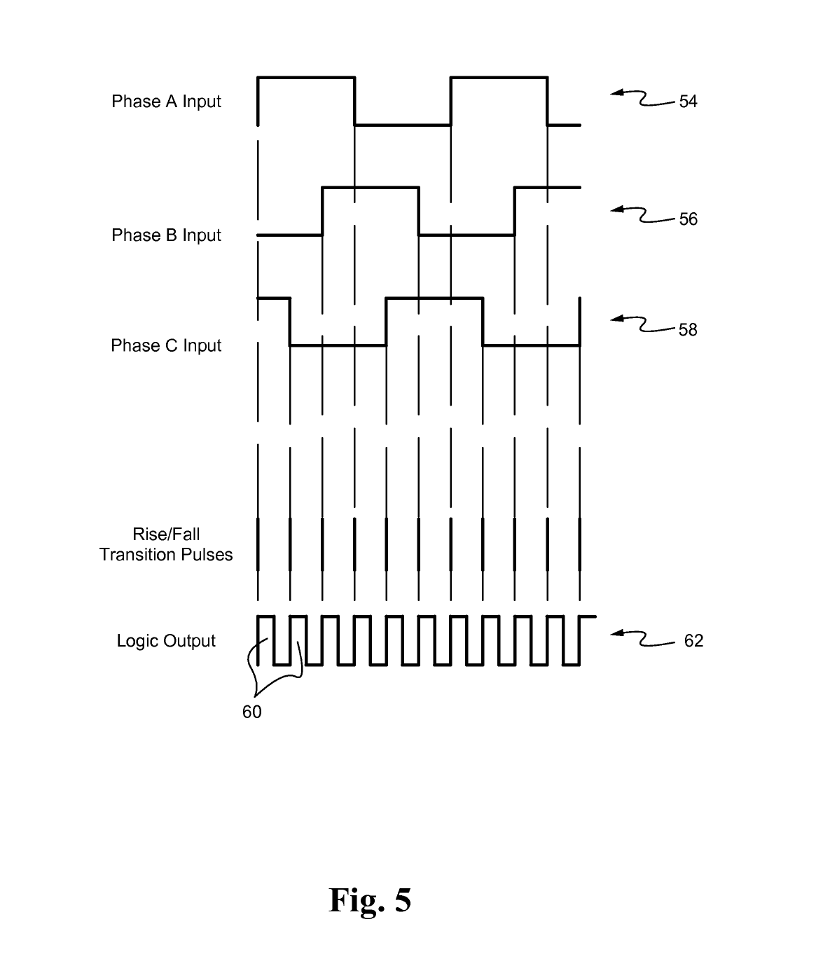

Referring back to FIG. 3, the three phase-shifted pulse signals generated by the zero-cross detectors 50 may be communicated to a combinational logic circuit 52 to be combined into a single or combined pulse signal. As shown in FIG. 5, for example, the logic circuit 52 may logically combine the three pulse signals 54, 56, 58 based on any transitions detected therein. Specifically, the logic circuit 52 may be configured to output a logic pulse 60 for each rise or fall transition detected in the pulse signals 54, 56, 58 corresponding to any of the three phase inputs A, B, C. As illustrated in FIG. 5, the combined logic signal 62 may be generated such that the frequency thereof is at least greater than that of each input phase signal 54, 56, 58, for example, by six times that of each phase signal 54, 56, 58, so as to output a tachometer signal 62 with a relatively high resolution. The resulting combined signal or logic tachometer signal 62 may be communicated to the TCU 32 for further processing.

The TCU 32 may conduct further calculations in determining the actual rotational speed of the generator 34. For example, based on the frequency of the tachometer signal provided by the combinational logic circuit 52, and further based on the number of phases and poles of the generator 34, the TCU 32 may be able to calculate the rotational speed of the generator 34 using the following relationships

=2 (1)

=— (2)

where fₒ is the frequency of the tachometer signal, f_{φ} is the frequency of the input phase signal, N_{φ} is the number of phases of the generator 34, Nₚ is the number of poles of the generator 34, and ω is the rotational speed of the generator 34 in revolutions per minute. By combining equations (1) and (2), the rotational speed of the generator 34 may be determined using

=—. (3)

In alternative modifications, the combinational logic circuit 52 may be configured to calculate the rotational speed of the generator 34 using the relationships identified above. The resulting generator speed may then in turn be communicated to the TCU 32 and/or other appropriate controllers of the wind turbine 10, for instance, in terms of revolutions per minute rather than logic pulse signals, for additional analyses.

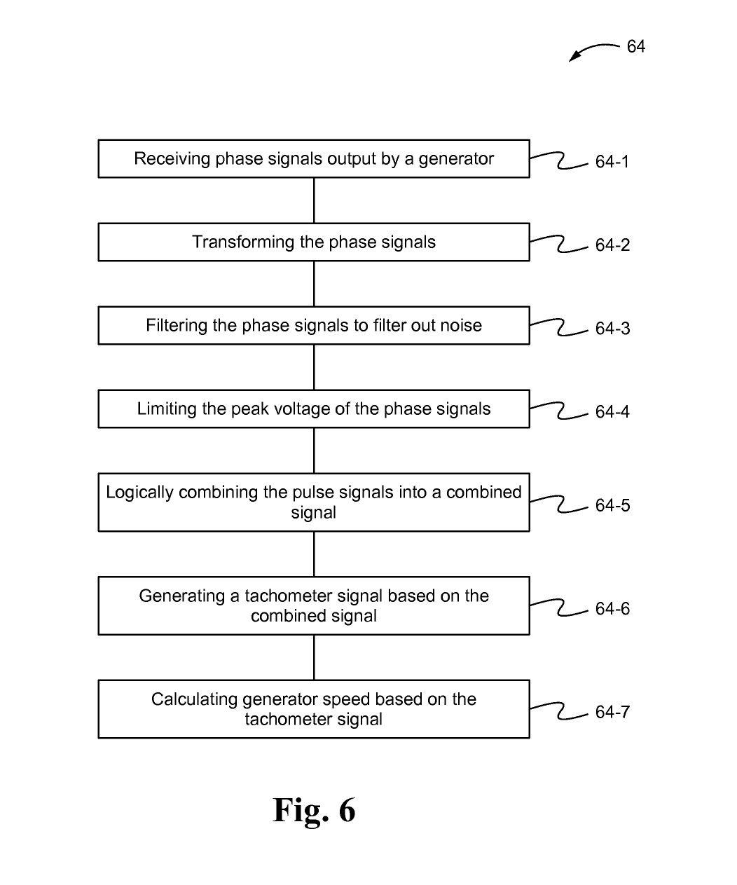

Turning to FIG. 6, one exemplary algorithm or method 64 by which the combinational logic circuit 52 and/or the TCU 32 may be configured or preprogrammed to generate a high resolution tachometer signal corresponding to generator speed is provided. In an initial step 64-1, the logic circuit 52 may be configured to electronically receive a phase signal from each phase of the associated generator 34. In an optional step 64-2, the logic circuit 52 may reduce the voltage in each of the phase signals to a more manageable level using, for instance, the step-down transformer 44 of FIG. 3. In another optional step 64-3, the logic circuit 52 may be configured to filter high frequency noise from each of the phase signals using, for example, the filters 46 of FIGS. 3 and 4. The logic circuit 52 may optionally or additionally be configured to limit the peak voltage of each phase signal using the limiters 48 of FIGS. 3 and 4, or the like, in step 64-4. In steps 64-5 and 64-6, the logic circuit 52 may further logically combine the pulse signals from each phase of the generator 34 to form a single, combined logic pulse signal. As shown in FIG. 5, for example, the logic circuit 52 may generate a combined signal of logic pulses, where each logic pulse corresponds to a detected change or transition in each of the pulse signals. The resulting combined signal may be transmitted to, for example, the TCU 32 as a tachometer signal from which the TCU 32 may be able to determine generator speed in step 64-7. Specifically, the TCU 32 may determine the rotational speed of the generator 34 based at least on the tachometer signal provided by the tachometer 40, the number of poles in the generator 34, and the number of phases in the generator 34, using for instance, equation (3) noted above. Alternatively or additionally, the logic circuit 52 may be preprogrammed with further computational means such that the tachometer 40 is able to directly output information relating to generator speed.

### INDUSTRIAL APPLICABILITY

In general, the present disclosure sets forth a tachometer for a low-speed generator, such as a direct drive wind turbine generator, which offers high resolution feedback for accurately determining the generator speed at minimal cost. More specifically, the disclosed tachometer observes each of a plurality of phase signals that is output by a multi-phase generator, and generates square wave or pulse signals corresponding to the phase signals using a series of zero-cross detectors. The tachometer then derives the frequency in each phase by tracking rise and fall transitions in the respective pulse signals. A combinational logic circuit of the tachometer combines the frequency information retrieved from each phase to result in a combined logic pulse signal or tachometer signal which exhibits a frequency that is a scalar multiple of the frequency in each observed phase signal. Based on the frequency of the resulting tachometer signal, the number of poles in the generator, and the number of phases in the generator, the logic circuit and the turbine control unit (TCU) is then able to compute the rotational speed of the generator.

As the disclosed tachometer derives generator speed based on a plurality of phase signals, received directly from the primary generator rather than indirectly through the single-phase of a secondary generator, the present disclosure offers higher resolution feedback and more accurate calculations, especially for low-speed applications such as direct drive wind turbines. Also, by eliminating the need for installation of an additional, single-phase generator and any gear sets associated therewith, the disclosed tachometer can be easily implemented in wind turbine settings having limited access to a main shaft and other related gearing assemblies. The simplicity of the present disclosure also minimizes costs, facilitates implementation with new installations, and enables retrofitment onto existing applications.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A tachometer for a generator, comprising:
a plurality of filters configured to receive a plurality of generator phase signals, the filters converting each phase signal into a corresponding filtered signal;
a plurality of zero-cross detectors configured to generate pulse signals responsive to zero-crossings detected in each filtered signal; and
a logic circuit in communication with each zero-cross detector, the logic circuit being configured to receive the pulse signals, logically combine the pulse signals into a combined signal, and generate a tachometer signal based on the combined signal, the tachometer signal corresponding to a rotational speed of the generator.

2. The tachometer of claim 1, wherein the logic circuit further communicates the tachometer signal to a turbine control unit (TCU), the TCU being configured to compute the rotational speed of the generator based on the tachometer signal, the number of phases, and the number of poles of the generator.

3. The tachometer of claim 1, wherein the logic circuit is further configured to compute a rotational speed of the generator based on the tachometer signal, the number of phases, and the number of poles of the generator.

4. The tachometer of claim 1, wherein the filters are configured to filter out high frequency noise and limit peak voltage in the phase signals.

5. The tachometer of claim 1, wherein each pulse signal generated by the zero-cross detectors includes single-ended square waves corresponding to the phase signal associated therewith.

6. The tachometer of claim 1, further comprising a transformer configured to receive the phase signals and generate corresponding transformed signals to be received by the filters, the transformer being configured to step-down the voltage of each phase signal.

7. The tachometer of claim 1, wherein the frequency of the tachometer signal is a scalar multiple of the phase signal frequency.

8. The tachometer of claim 1 being configured for use with a generator of a low-speed direct drive wind turbine.

9. A generator system, comprising:
a multi-phase stator;
a rotor rotatably disposed within the stator, the rotor having a plurality of poles configured to electromagnetically interact with the stator and induce a phase signal in each phase while rotating relative to the stator;
a plurality of zero-cross detectors in communication with the phase signals, the zero-cross detectors being configured to generate pulse signals responsive to zero-crossings detected in each filtered signal; and
a logic circuit in communication with each zero-cross detector, the logic circuit being configured to receive the pulse signals, logically combine the pulse signals into a combined signal, and generate a tachometer signal based on the combined signal, the tachometer signal corresponding to a rotational speed of the generator.

10. The generator system of claim 9, wherein the logic circuit further communicates the tachometer signal to a turbine control unit (TCU), the TCU being configured to compute the rotational speed of the generator based on the tachometer signal, the number of phases, and the number of poles of the generator.

11. The generator system of claim 9, wherein the logic circuit is further configured to compute a rotational speed of the generator based on the tachometer signal, the number of phases, and the number of poles of the generator.

12. The generator system of claim 9, further comprising a transformer configured to receive the phase signals and generate transformed signals to be communicated to the zero-cross detectors, the transformer being configured to step-down the voltage of each phase signal.

13. The generator system of claim 9, further comprising a plurality of filters in communication with the phase signals and configured to generate filtered signals to be received by the zero-cross detectors, the filters being configured to filter out high frequency noise and limit peak voltage in the phase signals.

14. The generator system of claim 9, wherein each pulse signal generated by the zero-cross detectors includes single-ended square waves corresponding to the phase signal associated therewith.

15. The generator system of claim 9 being a multi-phase, multi-pole synchronous generator configured for use with a low-speed direct drive wind turbine, the frequency of the tachometer signal being a scalar multiple of the phase signal frequency.

16. A method of determining a rotational speed of a generator, comprising the steps of:
receiving a phase signal from each phase of the generator;
generating a pulse signal based on zero-crossings detected in each phase signal;
logically combining the pulse signal from each phase into a combined signal;
generating a tachometer signal based on the combined signal; and
calculating the rotational speed of the generator based on the tachometer signal, the number of phases, and the number of poles of the generator.

17. The method of claim 16, wherein the frequency of the tachometer signal is a scalar multiple of the phase signal frequency.

18. The method of claim 16, further comprising the step of transforming each phase signal into a transformed signal of a relatively low voltage, the pulse signals being generated based on zero-crossings detected in the transformed signals.

19. The method of claim 16, further comprising the steps of filtering and limiting each phase signal into a filtered signal, the steps of filtering and limiting being configured to filter out high frequency noise and limit peak voltage in each phase signal.

20. The method of claim 16, further comprising the step of communicating the tachometer signal corresponding to the rotational speed of the generator to a turbine control unit (TCU).
